(19) United States
(12) Patent Application Publication
(10) Pub. No.: US 2024/0195517 A1
(43) Pub. Date: Jun. 13, 2024

(54) COMMUNICATION DEVICE, COMMUNICATION SYSTEM, COMMUNICATION METHOD, COMMUNICATION PROGRAM

(71) Applicant: OMRON CORPORATION, Kyoto-shi (JP)

(72) Inventors: Takashi MIURA, Kyoto-shi (JP); Hideki CHUJO, Kyoto-shi (JP); Hideaki KOJIMA, Kyoto-shi (JP); Toshiyasu MIWATA, Kyoto-shi (JP); Hiroyuki MINO, Kyoto-shi (JP); Masahiro ITOH, Kyoto-shi (JP)

(73) Assignee: OMRON CORPORATION, Kyoto-shi (JP)

(21) Appl. No.: 18/519,120

(22) Filed: Nov. 27, 2023

(30) Foreign Application Priority Data
Dec. 12, 2022 (JP) 2022-197787

(51) Int. Cl. H04B 17/318

(52) U.S. Cl. CPC H04B 17/328

(57) ABSTRACT

A communication system comprises a communication device that acquires output signals from sensors, a cloud server, a sensor, etc., and transmits these signals to a cloud server. The communication device has a control unit, a communication unit, and a communication control unit. The communication unit transmits the output signal acquired by the control unit to the cloud server. The communication control unit acquires the radio field strength of the output signal transmitted from the communication unit. The cloud server has a data input unit and a data analysis unit. The data input unit acquires data about the output signal and radio field strength from the communication unit. The data analysis unit analyzes the communication environment between the communication device and the cloud server on the basis of the radio field strength.

### CROSS-REFERENCE TO RELATED APPLICATIONS

THIS APPLICATION CLAIMS PRIORITY TO JAPANESE PATENT APPLICATION NO. 2022-197787 FILED ON DEC. 12, 2022. THE ENTIRE DISCLOSURE OF JAPANESE PATENT APPLICATION NO. 2022-197787 IS HEREBY INCORPORATED HEREIN BY REFERENCE.

### BACKGROUND

### Technical Field

The present invention relates to a communication device, a communication system, a communication method, and a communication program with which an output signal is acquired from an external device and is transmitted to an external server.

### Description of the Related Art

Communication devices that transmit the output from an external device, such as a sensor, to a management server or the like have been used in recent years.

For example, Patent Literature 1 discloses an IoT system and a management server comprising a plurality of node terminals each having a wireless communication module and a sensor, and a management server, and with which sensor information is transmitted through a wireless communication module to the management server, sensor information is received, whether or not a notification is necessary is determined on the basis of the sensor information, and a message is posted to a chat room in the event that notification is necessary.

### CITATION LIST

### Patent Literature

Patent Literature 1: JP-A 2022-117261

### SUMMARY

### Problem to be Solved by the Invention

However, the following problem is encountered with the conventional IT system described above.

Specifically, the IoT system disclosed in the above publication is often installed in mountainous areas or on the rooftops of buildings, for example, and although the radio field strength is checked at the installation stage, weather conditions, base station congestion, and other such external factors could deteriorate after installation, making it difficult to ascertain the deterioration of the communication environment in real time.

It is an object of the present invention to provide a communication device, a communication system, a communication method, and a communication program with which deterioration of the communication environment can be monitored in real time even if the communication environment deteriorates due to external factors.

### Means for Solving Problem

The communication device according to the first invention is a communication device that acquires an output signal from an external device and transmits it to an external server, and comprises a signal acquisition unit, a communication unit, and an analysis unit. The signal acquisition unit acquires an output signal from an external device. The communication unit transmits the output signal acquired by the signal acquisition unit to the external server.

The analysis unit acquires the radio field strength of the signal transmitted from the communication unit to the external server, and analyzes the communication environment between the communication unit and the external server.

Here, in a communication device that acquires an output signal from an external device such as a sensor and transmits this signal to an external server, the radio field strength of the signal transmitted from the communication unit is acquired, and the communication environment between the communication unit and the external server is analyzed.

Here, the external device includes, for example, various kinds of device such a sensor, relay, etc.

The external server includes, for example, a server device, a cloud server equipped with a storage unit, or the like.

The communication unit may communicate with the external server using a different communication method such as LTE (registered trademark; Long Term Evolution), Wi-Fi (registered trademark), LoRa (registered trademark; Long Range), etc., or communication may be performed using the same communication method.

The radio field strength can be, for example, a value of RSSI (received signal strength indicator) or RSRP (reference signal received power).

This allows the communication device to monitor changes in the communication environment between itself and an external server and transmit the results to the external server, etc., making it easy to recognize changes in the communication environment after the communication device has been installed.

As a result, if the communication environment should deteriorate due to external factors, the deterioration of the communication environment can be monitored in real time.

The communication system according to the second invention comprises an external device, an external server, and a communication device that acquires an output signal from the external device and transmits it to the external server. The communication device has a signal acquisition unit, a communication unit, and a radio field strength acquisition unit. The signal acquisition unit acquires an output signal from an external device. The communication unit transmits the output signal acquired by the signal acquisition unit to an external server. The radio field strength acquisition unit obtains the radio field strength of the output signal transmitted from the communication unit. The external server has a data acquisition unit and an analysis unit. The data acquisition unit acquires data about the output signal and radio field strength from the communication unit of the communication device. The analysis unit analyzes the communication environment between the communication device and the external server on the basis of the radio field strength.

Here, in a communication system including a communication device that acquires an output signal from an external device such as a sensor and transmits the signal to an external server, the radio field strength of the signal transmitted from the communication unit is acquired, and the communication environment between the communication device and the external server is analyzed.

Here, the external device includes, for example, various devices such as various types of sensor and relay.

The external server includes, for example, a server device, a cloud server equipped with a storage unit, and the like.

The communication unit may communicate with the external server using a different communication method such as LTE (registered trademark; Long Term Evolution), Wi-Fi (registered trademark), LoRa (registered trademark; Long Range), etc., or communication may be performed using the same communication method.

The radio field strength can be, for example, a value of RSSI (received signal strength indicator) or RSRP (reference signal received power).

Consequently, in an external server acquired from the communication device, changes in the communication environment between the communication device and the external server can be monitored, making it easy to recognize changes in the communication environment after the communication device has been installed.

As a result, even if the communication environment deteriorates due to external factors, it is possible to monitor the deterioration of the communication environment in real time.

The communication system according to the third invention is the communication system according to the second invention, wherein the analysis unit determines that the communication environment has deteriorated if the radio field strength acquired by the data acquisition unit is lower than the average value of past radio field strengths by at least a specific threshold.

The value of past radio field strength may be a median value, mode value, etc., instead of an average value.

This makes it easy to recognize deterioration in the communication environment by analyzing the communication environment according to whether or not the acquired radio field strength is lower than a specific threshold compared to the average value of the most recent radio field strength, for example.

The communication system according to the fourth invention is the communication system according to the third invention, wherein the analysis unit updates the threshold by averaging the radio field strength acquired during a specific period in which the data acquisition unit was able to receive the output signal properly.

Consequently, deterioration of the communication environment can be accurately determined by using the latest threshold value updated using the average value of radio field strength acquired under a normal communication environment.

The communication system according to the fifth invention is the communication system according to the second or third invention, wherein the analysis unit determines that the communication environment has deteriorated if data loss has occurred at least a specific number of times when receiving the output signal acquired by the data acquisition unit.

Consequently, it can be determined that the communication environment has deteriorated if the data acquired by the data acquisition unit on the external server side is intermittent and there is loss at least a specific number of times.

The communication system according to the sixth invention is the communication system according to the second or third invention, wherein the external server further has a notification unit that notifies the user of the analysis result for the communication environment in the analysis unit.

Consequently, the administrator, etc., of the communication system can take appropriate measures against the deterioration of the communication environment when the terminal of the administrator, etc., receives analysis results indicating changes in the communication environment in real time, for example.

The communication system according to the seventh invention is the communication system according to the second or third invention, wherein the analysis unit uses RSSI (received signal strength indicator) or RSRP (reference signal received power) data as the data for analysis using radio field strength.

Consequently, whether or not communication using radio field strength is possible can be determined by acquiring the radio field strength (the above-mentioned RSSI, RSRP, etc.) from an antenna provided to the communication unit, for example.

The communication system according to the eighth invention is the communication system according to the second or third invention, wherein the external server further has a storage unit that stores data about the output signal and the radio field strength acquired by the data acquisition unit.

Consequently, whether or not the communication environment has deteriorated within the external server can be determined by storing the output signal data and radio field strength data of the external device acquired by the data acquisition unit in the external server.

The communication system according to the ninth invention is the communication system according to the second or third invention, wherein the external device includes either a weather sensor that acquires weather data, a power monitoring sensor that acquires power information, or an agricultural sensor that acquires information from equipment that grows crops.

Consequently, various kinds of data acquired from various sensors can be stably transmitted to an external server by using the various sensors described above as external devices.

The communication method according to the tenth invention is communication method that makes use of a communication system comprising an external device, an external server, and a communication device that acquires an output signal from the external device and transmits it to the external server, the method comprising a signal acquisition step, a communication step, a radio field strength acquisition step, a data acquisition step, and an analysis step. In the signal acquisition step, the signal acquisition unit of the communication device acquires an output signal from an external device. In the communication step, the communication unit of the communication device transmits the output signal acquired by the signal acquisition unit to an external server. In the radio field strength acquisition step, the radio field strength acquisition unit of the communication device acquires the radio field strength of the output signal transmitted from the communication unit. In the data acquisition step, the data acquisition unit of the external server acquires data about the output signal and radio field strength from the communication unit of the communication device. In the analysis step, the analysis unit of the external server analyzes the communication environment between the communication device and the external server on the basis of the radio field strength.

Here, in a communication system including a communication device that acquires an output signal from an external device such as a sensor and transmits this signal to an external server, the radio field strength of the signal transmitted from the communication unit is acquired, and the communication environment between the communication device and the external server is analyzed.

Here, the external device includes, for example, various kinds of sensor, relay, etc.

The external server includes, for example, a server device, a cloud server equipped with a storage unit, or the like.

The communication unit may communicate with the external server using a different communication method such as LTE (registered trademark; Long Term Evolution), Wi-Fi (registered trademark), LoRa (registered trademark; Long Range), etc., or communication may be performed using the same communication method.

The radio field strength can be, for example, a value of RSSI (received signal strength indicator) or RSRP (reference signal received power).

Consequently, changes in the communication environment after the communication device has been installed can be easily recognized by monitoring changes in the communication environment between the communication device and an external server acquired from the communication device.

As a result, if the communication environment deteriorates due to external factors, it is possible to monitor the deterioration of the communication environment in real time.

The communication program according to the eleventh invention is a communication program executed by a communication system comprising an external device, an external server, and a communication device that acquires an output signal from the external device and transmits it to the external server, the program causing a computer to execute a communication method comprising a signal acquisition step, a communication step, a radio field strength acquisition step, a data acquisition step, and an analysis step. In the signal acquisition step, a signal acquisition unit of the communication device acquires an output signal from an external device. In the communication step, a communication unit of the communication device transmits the output signal acquired by the signal acquisition unit to the external server. In the radio field strength acquisition step, a radio field strength acquisition unit of the communication device acquires the radio field strength of the output signal transmitted from the communication unit. In the data acquisition step, a data acquisition unit of the external server acquires data about the output signal and radio field strength from the communication unit of the communication device. In the analysis step, an analysis unit of the external server analyzes the communication environment between the communication device and the external server on the basis of the radio field strength.

Here, in a communication system including a communication device that acquires an output signal from an external device such as a sensor and transmits the signal to an external server, the radio field strength of the signal transmitted from the communication unit is acquired, and the communication environment between the communication device and the external server is analyzed.

Here, the external device includes, for example, various devices such as various types of sensor and relay.

The external server includes, for example, a server device, a cloud server equipped with a storage unit, and the like.

The communication unit may communicate with the external server using a different communication method such as LTE (registered trademark; Long Term Evolution), Wi-Fi (registered trademark), LoRa (registered trademark; Long Range), etc., or communication may be performed using the same communication method.

The radio field strength can be, for example, a value of RSSI (received signal strength indicator) or RSRP (reference signal received power).

Consequently, in an external server acquired from the communication device, changes in the communication environment between the communication device and the external server can be monitored, making it easy to recognize changes in the communication environment after the communication device has been installed.

As a result, even if the communication environment deteriorates due to external factors, it is possible to monitor the deterioration of the communication environment in real time.

### Effects

With the communication device according to the present invention, if the communication environment should deteriorate due to external factors, it is possible to monitor the deterioration of the communication environment in real time.

### BRIEF DESCRIPTION OF THE DRAWINGS

FIG. 1 is a block diagram showing the configuration of a communication system according to an embodiment of the present invention;

FIG. 2 is a diagram illustrating types of radio field strength used for determination in the communication system in FIG. 1;

FIG. 3 is a diagram showing sensor log data stored in storage units on the communication device side and the cloud server side included in the communication system in FIG. 1;

FIG. 4 is a diagram showing communication environment data stored in storage units on the communication device side and the cloud server side included in the communication system in FIG. 1;

FIG. 5 is a diagram showing threshold data that is used for communication environment determination and is stored in storage units on the communication device side and the cloud server side included in the communication system in FIG. 1;

FIG. 6 is a diagram showing the overall sequence of processing in the communication system in FIG. 1;

FIG. 7 is a flowchart showing the flow of processing of a communication method implemented by the communication system in FIG. 1; and

FIG. 8 is a block diagram showing the configuration of a communication system including a communication device according to another embodiment of the present invention.

### DETAILED DESCRIPTION OF THE EMBODIMENT

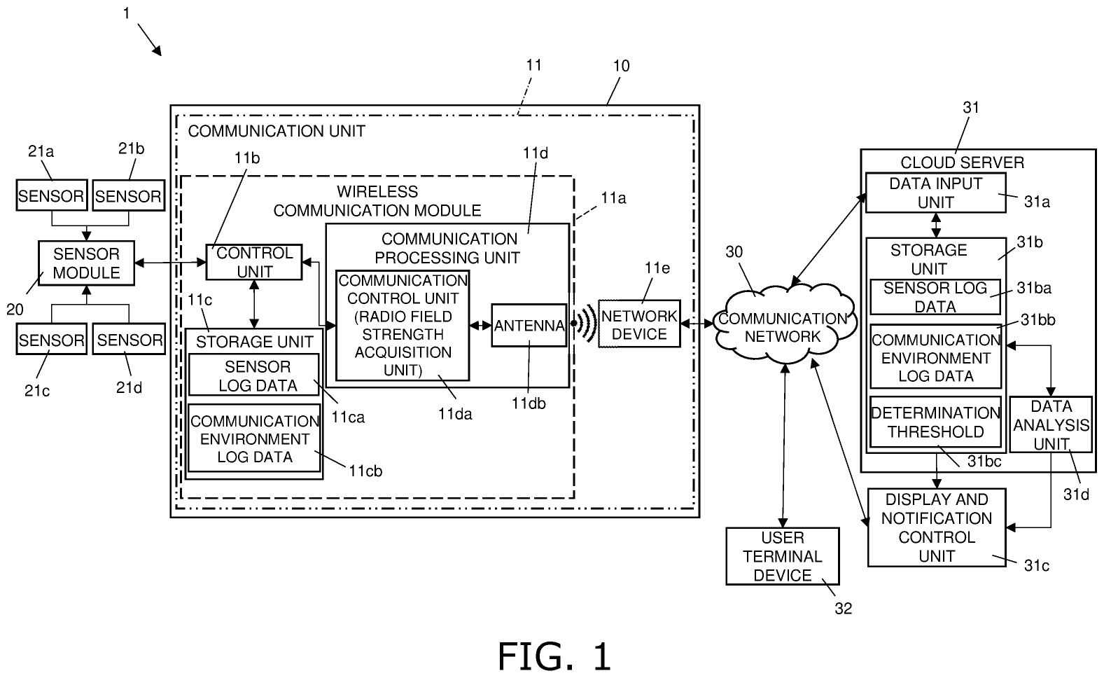

A communication system 1 according to an embodiment of the present invention will now be described using FIGS. 1 to 7.

In this embodiment, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### (1) Configuration of Communication System 1

As shown in FIG. 1, the communication system 1 according to the present embodiment is configured around a communication device 10 that acquires various kinds of data (output signals) sensed by a plurality of sensors (external devices) 21a to 21d via a sensor module 20, and transmits this data to a cloud server 31. That is, the communication system 1 comprises the communication device 10, the sensor module 20 and the sensors 21a to 21d, a communication network 30, the cloud server (external server) 31, and a user terminal device 32.

As shown in FIG. 1, the communication device 10 acquires various kinds of data sensed by the sensors 21a to 21d and the radio field strength of communication via the sensor module 20, and transmits them to the cloud server 31.

The detailed configuration of the communication device 10 will be described in detail below.

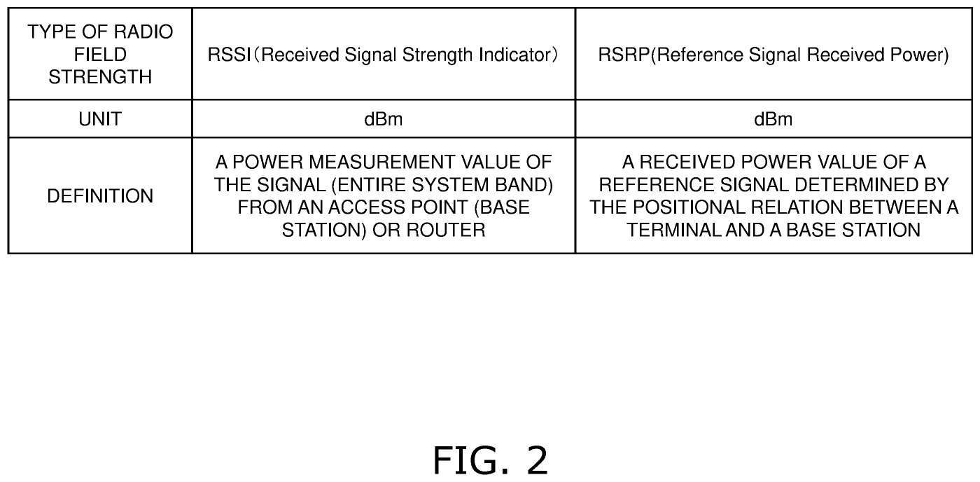

Here, the radio field strength indicating the communication environment between the communication unit 11 provided to the communication device 10 and the cloud server 31 is expressed as a value of the radio field strength acquired from an antenna 11db of the communication unit 11 (discussed below), and a measured value of RSSI (received signal strength indicator) or RSRP (reference signal received power) can be used as shown in FIG. 2, for example.

As shown in FIG. 2, RSSI (received signal strength indicator) is a value given in units of dBm (decibel milliwatts), and is expressed as a power measurement value of the signal (entire system band) from an access point (base station) or router. The larger the RSSI value is in the positive direction, the stronger a radio wave is judged to be. For example, −30 dBm or more is determined to be “extremely strong,” −67 dBm or more is “very strong,” −70 dBm or more is “strong,” and −80 dBm or more is “weak.”

RSRP (reference signal received power) is a value given in units of dBm (decibel milliwatts), and is expressed as a received power value of a reference signal determined by the positional relation between a terminal and a base station. For example, just as with RSSI, the larger RSRP value is in the positive direction, the stronger a radio wave is judged to be. For example, −44 dBm or more is determined to be “extremely strong,” −90 dBm or more is “very strong,” −100 dBm or more is “strong,” and −120 dBm or more is “very weak.”

The sensor module 20 is connected to the sensors 21a to 21d, and transmits various kinds of data sensed by the sensors 21a to 21d to the communication device 10.

The sensors 21a to 21d include, for example, a weather sensor that acquires weather data (barometric pressure, temperature, humidity, etc.), a power monitoring sensor that acquires power information in homes, offices, or the like, and an agricultural sensor that acquires information from equipment used to grow crops (sunshine hours, temperature, humidity, acceleration, etc.).

The communication network 30 connects the communication device 10 and the cloud server 31, and enables wireless communication between the communication device 10 and the cloud server 31.

The cloud server 31 is a virtual server device provided in a cloud space on the Internet, and stores various kinds of data transmitted via the communication device 10. As shown in FIG. 1, the cloud server 31 has a data input unit (data acquisition unit) 31a, a storage unit 31b, a display and notification control unit (notification unit) 31c, and a data analysis unit (analysis unit) 31d.

The data input unit 31a receives the input of various kinds of data transmitted from the communication device 10 via the communication network 30.

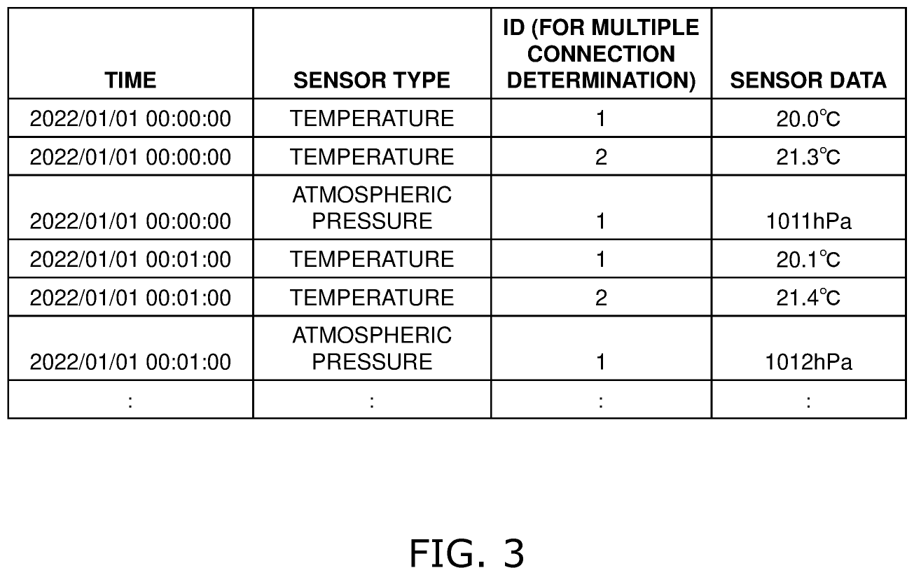

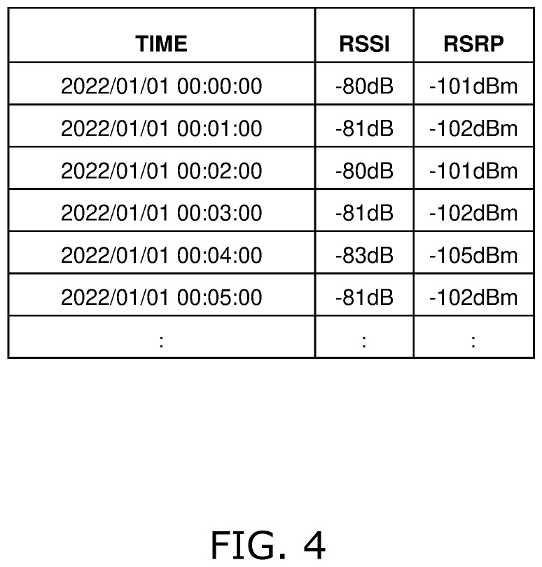

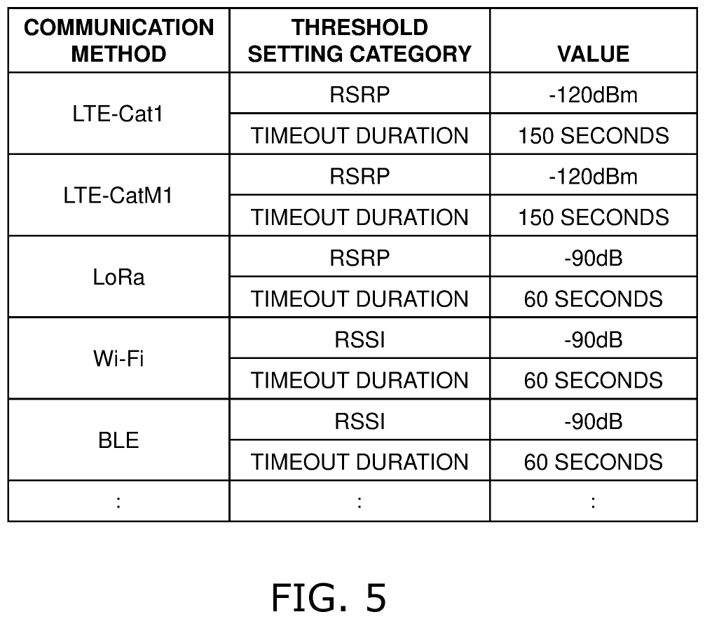

As shown in FIG. 1, the storage unit 31b stores the various data sensed by the sensors 21a to 21d and received from the communication device 10 via the communication network 30 as sensor log data 31ba (see FIG. 3). The storage unit 31b stores communication environment log data 31bb (see FIG. 4) indicating the communication environment between the communication device 10 and the cloud server 31 as a value of radio field strength, and a determination threshold value 31bc that is used in analyzing the communication environment (see FIG. 5).

The sensor log data 31ba is various kinds of data sensed by the sensors 21a to 21d, and includes, for example, the sensing time of the sensors 21a to 21d, the type of the sensors 21a to 21d (temperature, humidity, atmospheric pressure, etc.), the ID of the communication unit 11 (“1” or “2”), and sensor data (20.0° C., 1011 hPa, etc.), as shown in FIG. 3.

The communication environment log data 31bb is data about the radio field strength acquired from the antenna 11db of the communication unit 11, and as shown in FIG. 4, data such as the date and time when the radio field strength was acquired, and the radio field strength (RSRP value, RSRP value), acquired every other hour, is recorded.

The determination threshold value 31bc is a threshold used in processing to analyze the communication environment using radio field strength (discussed below), and as shown in FIG. 5, includes the communication method (LTE, LoRa, Wi-Fi, BLE, etc.) employed in the communication unit 11, the threshold setting categories (RSRP, timeout duration), and the values of the threshold setting categories (dBm, seconds).

For example, when the communication unit 11 uses LTE-Cat1 or LTE-CatM1 as the communication method, the radio field strength threshold (RSRP) is set to −120 dBm, and the timeout duration threshold is set to 150 seconds.

Also, when the communication unit 11 uses LoRa as the communication method, the radio field strength threshold (RSSI) is set to −90 dB, and the timeout duration threshold is set to 60 seconds.

Furthermore, when the communication unit 11 uses Wi-Fi or BLE as the communication method, the radio field strength threshold (RSSI) is set to −90 dBm, and the timeout duration threshold is set to 60 seconds.

The display and notification control unit 31c displays the sensor log data 31ba and the communication environment log data 31bb on the user terminal device 32 via the communication network 30 to notify the user of the communication environment between the communication device 10 and the cloud server 31, etc.

The data analysis unit 31d uses the radio field strength data acquired from the communication device 10 by the data input unit 31a of the cloud server 31 to analyze the communication environment between the communication device 10 and the cloud server 31.

More specifically, if the radio field strength acquired by the data input unit 31a is lower than the average value of the radio field strength in the past (such as the past day) by at least a specific threshold, the data analysis unit 31d determines that the communication environment has deteriorated.

Consequently, deterioration of the communication environment can be easily recognized depending on whether or not the acquired radio field strength is lower than a specific threshold value when compared with the average value of the most recent radio field strength, for example.

Here, the data analysis unit 31d uses RSSI (received signal strength indicator) or RSRP (reference signal received power) data as the data for determination using radio field strength.

Also, the data analysis unit 31d averages the radio field strengths acquired during a specific period in which the data input unit 31a was able to receive the output signal properly, and updates the threshold value.

Consequently, deterioration of the communication environment can be accurately determined by using the average value of the radio field strength acquired under a normal communication environment to update the threshold value to the latest value.

Furthermore, the data analysis unit 31d determines that the communication environment has deteriorated if there is data loss at least a specific number of times when receiving the output signal acquired by the data input unit 31a.

For example, if 10 pieces of sensor data, etc., are supposed to be received at specific time intervals (once every minute) during a specific time period (10 minutes), but only seven pieces of data have been received, the data analysis unit 31d determines that there are three pieces of missing data.

Consequently, if the data acquired by the data input unit 31a on the cloud server 31 side is intermittent and there is loss at least a specific number of times (such as three) within a specific length of time (10 minutes), it can be determined that the environment communication has deteriorated.

The user terminal device 32 is a terminal owned by an administrator who manages various kinds of data sensed using the sensors 21a to 21d, and is connected to the cloud server 31 via the communication network 30. The user terminal device 32 displays information about the determination result (communication environment, etc.) obtained using the radio field strength in the communication device 10 (discussed below).

### (2) Configuration of Communication Device 10

The communication device 10 according to this embodiment is a device that transmits detection results acquired by the sensors 21a to 21d via the sensor module 20 to the cloud server 31, and comprises the communication unit 11 as a communication means, as shown in FIG. 11.

The communication unit 11 is one of a plurality of communication means included in the communication device 10, and makes use of LTE (registered trademark; Long Term Evolution), Wi-Fi (registered trademark), LoRa (registered trademark), (BLE (registered trademark; Bluetooth (registered trademark) Low Energy), or another such communication method. As shown in FIG. 1, the communication unit 11 has a wireless communication module 11a and a network device 11e.

As shown in FIG. 1, the wireless communication module 11a includes a control unit (signal acquisition unit) 11b, a storage unit 11c, and a communication processing unit (radio field strength acquisition unit) 11d.

The control unit (signal acquisition unit) 11b is connected to the sensor module 20 as shown in FIG. 1, and acquires detection results (output signals) from the sensors 21a to 21d via the sensor module 20. Also, the control unit 11b stores the acquired detection results as sensor log data 11ca in the storage unit 11c. Furthermore, the control unit 11b is connected to the communication processing unit 11d, acquires data about radio field strength (discussed below), and stores this in the storage unit 11c as the communication environment log data 11cb.

As shown in FIG. 1, the storage unit 11c stores the sensor log data 11ca (see FIG. 3) and the communication environment log data 11cb (see FIG. 4).

The sensor log data 11ca and the communication environment log data 11cb stored in the storage unit 11c are similar to the sensor log data 31ba and the communication environment log data 31bb stored in the storage unit 31b on the cloud server 31 side as discussed above.

The communication processing unit 11d transmits the detection results of the sensors 21a to 21d acquired by the control unit 11b to the cloud server 31 via the network device 11e and the communication network 30. As shown in FIG. 1, the communication processing unit 11d has a communication control unit 11da and the antenna 11db.

The communication control unit 11da controls communication between the communication device 10 and the cloud server 31 via the communication network 30. More specifically, the communication control unit 11da acquires the radio field strength of the signal transmitted from the antenna 11db of the communication unit 11 to the cloud server 31, and transmits this to the cloud server 31 via the network device 11e and the communication network 30.

Also, the communication control unit 11da determines whether or not communication is possible, depending on whether or not a response signal is received from the cloud server 31 within a specific length of time when the detection results (output signals) are transmitted from the sensors 21a to 21d to the cloud server 31.

The antenna 11db transmits data such as detection results from the sensors 21a to 21d to the network device 11e. Also, the antenna 11db measures the radio field strength (RSSI value, RSRP value, etc.) as the strength of the signal being received by the antenna 11db.

The network device 11e is connected to the communication network 30, and transmits various kinds of data received from the wireless communication module 11a to the cloud server 31 via the communication network 30.

Processing to Analyze Communication Environment between Communication Device 10 and Cloud Server 31

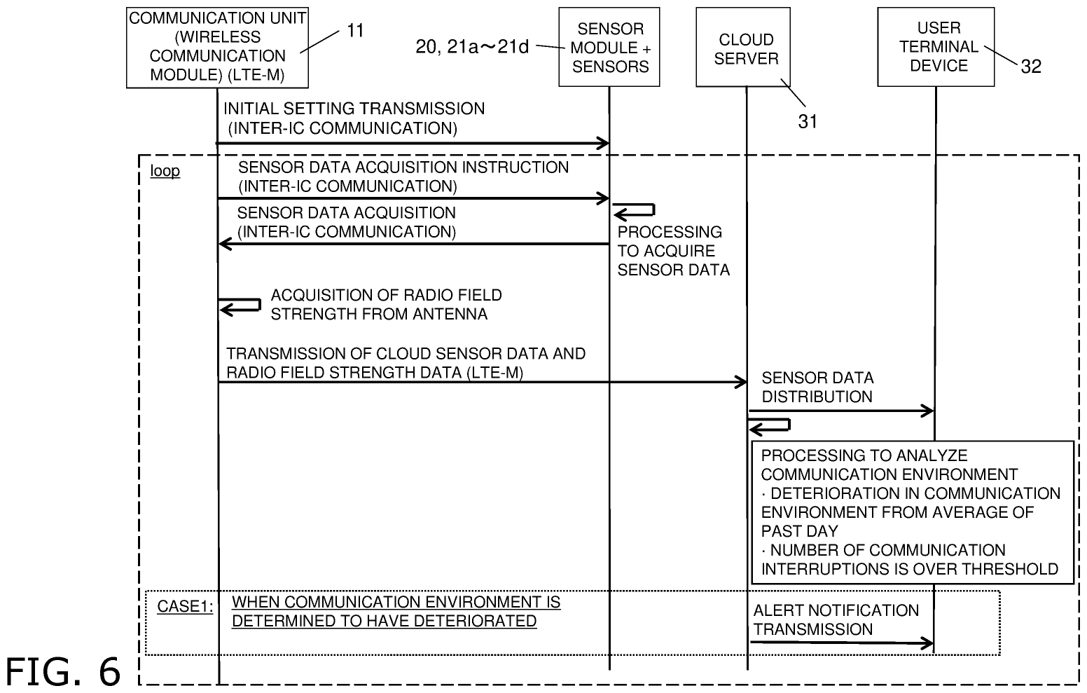

As shown in FIG. 6, the communication system 1 of this embodiment communicates with the communication unit 11 of the communication device 10, the sensor module 20 and the sensors 21a to 21d, the cloud server 31, and the user terminal device 32, and also performs processing to analyze the communication environment between the communication unit 11 and the cloud server 31.

That is, the communication device 10 first transmits initial settings from the communication unit 11 to the sensor module 20.

Then, the communication unit 11 transmits a sensor data acquisition instruction signal to the sensor module 20.

Upon receipt of the sensor data acquisition instruction signal from the communication unit 11, in response to this the sensor module 20 transmits the sensing results of the sensors 21a to 21d as sensor data (output signals) to the communication unit 11. Consequently, the communication unit 11 can acquire sensor data and store it in the storage unit 11c.

Then, in the communication unit 11, the communication control unit 11da in the communication processing unit 11d acquires data related to the radio field strength from the antenna 11db.

The data related to the radio field strength acquired by the communication unit 11 is, for example, RSSI (received signal strength indicator) or RSRP (reference signal received power) data, as mentioned above.

The communication control unit 11da of the communication unit 11 then transmits the sensor data and the radio field strength data acquired from the antenna 11db to the cloud server 31.

The cloud server 31 uses the radio field strength received from the communication unit 11 of the communication device 10 to perform processing to analyze the communication environment between the communication device 10 and the cloud server 31.

More specifically, the data analysis unit 31d of the cloud server 31 determines whether or not the communication environment has deteriorated depending on whether the radio field strength is lower than the average value of the radio field strength for the most recent day.

Also, the data analysis unit 31d determines whether or not the communication environment has deteriorated depending on whether the number of times that communication from the communication unit 11 to the cloud server 31 has been interrupted is at or above a specific threshold. Whether or not communication is interrupted can be determined from whether or not part of the sensor data or radio field strength data received from the communication unit 11 is missing.

Here, if the result of the analysis in the data analysis unit 31d is a determination that the communication environment has deteriorated, an alert notification indicating the deterioration of the communication environment is transmitted from the cloud server 31 to the user terminal device 32.

Consequently, the user who owns the user terminal device 32 can recognize that the communication environment of the communication device 10 has deteriorated, and can take appropriate measures aimed at the location where the communication device 10 is installed.

Communication Method with Communication Device 10

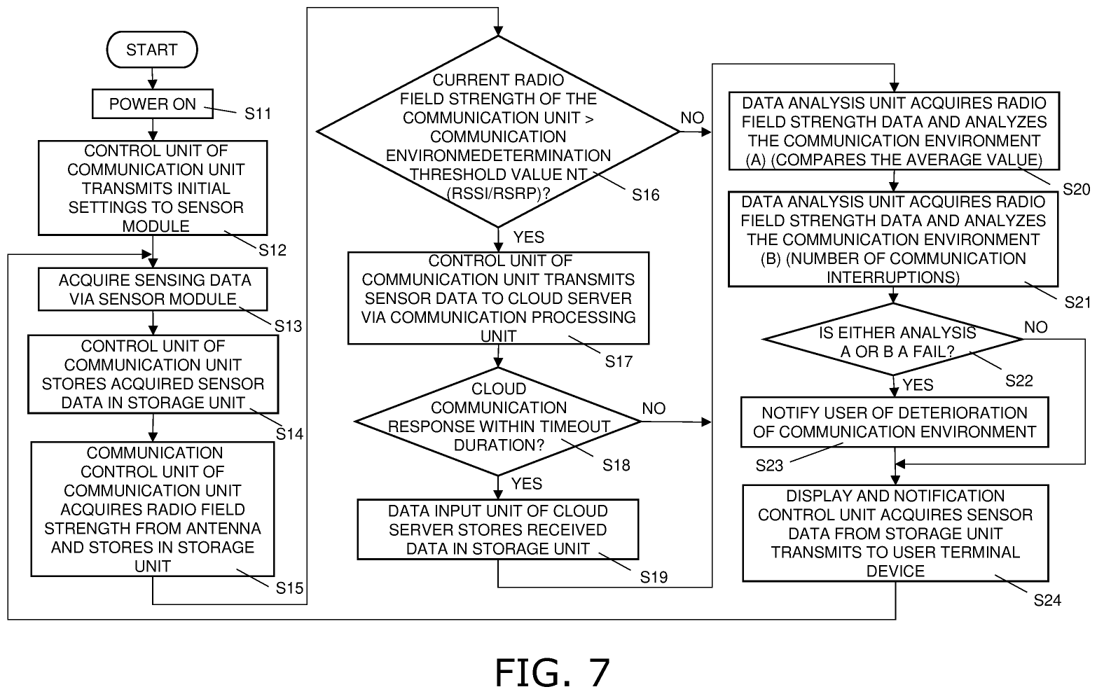

The communication method with the communication device 10 of this embodiment will now be described using the flowchart in FIG. 7.

In step S11, the power is turned on to the communication device 10.

Next, in step S12, the control unit 11b of the communication unit 11 transmits the initial settings to the sensor module 20.

Next, in step S13, the control unit 11b of the communication unit 11 acquires sensing results from the sensors 21a to 21d via the sensor module 20.

Next, in step S14, the control unit 11b of the communication unit 11 stores the acquired sensor data in the storage unit 11c.

Next, in step S15, the communication control unit 11da of the communication unit 11 acquires the radio field strength from the antenna 11db and stores this in the storage unit 11c as communication environment log data.

Next, in step S16, the current radio field strength of the communication unit 11 acquired in step S15 is compared with a communication environment determination threshold value (RSSI/RSRP), and the strength is over the threshold value, the processing proceeds to step S17. On the other hand, if the current radio field strength of the communication unit 11 is below the threshold value, the processing proceeds to step S20.

Next, in step S17, since it was determined in step S16 that the communication environment was good, the control unit 11b of the communication unit 11 transmits the sensor data to the cloud server 31 via the communication processing unit 11d.

Next, in step S18, after the sensor data has been transmitted from the communication unit 11, it is determined whether or not there was a response from the cloud server 31 within the determination threshold value (timeout duration) stored in the storage unit 11c. Here, if the communication unit 11 receives a response signal from the cloud server 31 within the specific timeout duration, the processing proceeds to step S19. On the other hand, if the communication unit 11 cannot receive a response signal from the cloud server 31 within the specific timeout duration, the communication environment between the communication unit 11 and the cloud server 31 is assumed to have deteriorated, so the processing proceeds to step S20.

Next, in step S19, the data input unit 31a of the cloud server 31 stores the sensor data and radio field strength data received from the communication unit 11 in the storage unit 31b.

Next, in step S20, the data analysis unit 31d of the cloud server 31 acquires radio field strength data from the storage unit 31b and analyzes the communication environment (A). More specifically, for example, the data analysis unit 31d compares the average value of the radio field strength for the most recent day with the current radio field strength, and if this is below a specific threshold, it is determined that the communication environment with 31 has deteriorated.

Next, in step S21, the data analysis unit 31d of the cloud server 31 acquires radio field strength data from the storage unit 31b and performs another analysis (B) of the communication environment. More specifically, for example, the data analysis unit 31d checks whether there is a loss of part of the data (communication interruption) stored in the storage unit 31b of the cloud server 31, and if the number of times of loss is at least a specific number, it is determined that the communication environment between the communication device 10 and the cloud server 31 has deteriorated.

Next, in step S22, the data analysis unit 31d determines whether either the analysis (A) in step S20 or the analysis (B) in step S21 is “fail” (the radio field strength is below a specific threshold value compared to the average value, or the number of communication interruptions (number of losses) is greater than a specific number of times).

Here, if it is determined that either analysis (A) or (B) is “fail,” the processing proceeds to step S23, and if it is determined that neither analysis (A) or (B) is “fail,” the processing proceeds to step S24.

Next, in step S23, since at least one of the analyzes (A) and (B) was determined in step S22 to be “fail,” the user is notified of the deterioration of the communication environment.

Next, in step S24, the display and notification control unit 31c of the cloud server 31 acquires sensor data from the storage unit 31b and transmits this to the user terminal device 32.

### Other Embodiments

An embodiment of the present invention was described above, but the present invention is not limited to or by the above embodiment, and various changes are possible without departing from the gist of the invention.

### (A)

The above embodiment was described using examples of implementing the present invention as a communication device and a communication method. However, the present invention is not limited to this.

For example, the present invention may be implemented as a communication program that causes a computer to execute a communication method that makes use of the communication device described above.

This program is stored in a memory (storage unit) installed in the communication device, and the CPU reads the communication program stored in the memory and causes the hardware to execute the steps. More specifically, the CPU reads the communication program and executes the above-mentioned signal acquisition step, communication step, radio field strength acquisition step, data acquisition step, and analysis step, by which the same effect as above can be obtained.

Also, the present invention may be implemented as a recording medium that stores a communication program.

### (B)

In the above embodiment, an example was given in which data about radio field strength used for determining the communication environment between the communication device 10 and the cloud server 31 was transmitted from the communication device 10 to the cloud server 31, and the data analysis unit provided to the cloud server 31 31d evaluated the communication environment. However, the present invention is not limited to this.

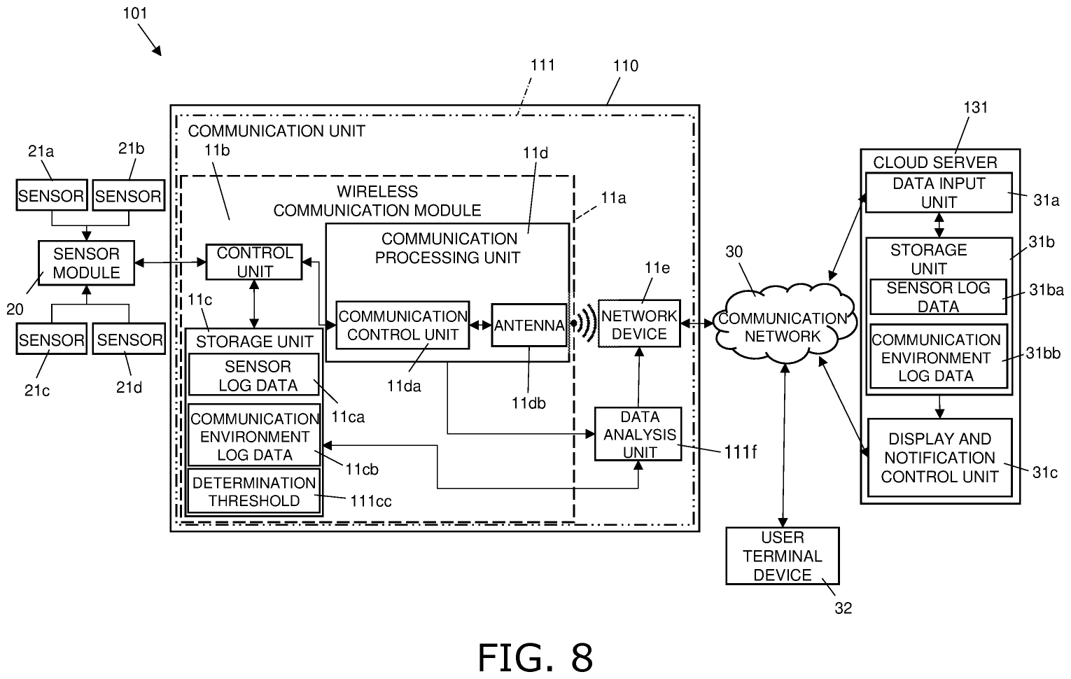

For example, as shown in FIG. 8, in a communication system 101, a data analysis unit 111f, which is the main part that analyzes the communication environment, is provided inside a communication unit 111 on the communication device 110 side.

In this case, in the communication unit 111 of the communication device 110, processing to analyze the communication environment with the cloud server 131 is performed using a determination threshold value 111cc stored in the storage unit 11c, and this result is transmitted to the cloud server 131, by which the same effect as above can be obtained.

### (C)

In the above embodiment, an example was given in which RSSI (received signal strength indicator) or RSRP (reference signal received power) data was used as data for determination using radio field strength. However, the present invention is not limited to this.

For example, some other determination data, such as RSRQ (reference signal received quality) or SINR (signal to interference plus noise ratio) data, may be used instead.

### (D)

In the above embodiment, an example was given in which various kinds of data (output signals) sensed by the four sensors 21a to 21d were transmitted to the communication device 10 via the sensor module 20. However, the present invention is not limited to this.

For example, output signals sent to the communication device may be sent from one, two, or three external devices (sensors, etc.), or may be sent from five or more external devices.

### (E)

In the above embodiment, an example was given in which the communication device 10 acquired output signals from various sensors, such as a weather sensor, a power monitoring sensor, and an agricultural sensor, serving as external devices. However, the present invention is not limited to this.

For example, the communication device may acquire a power cutoff signal from an external device such as a relay and transmit this signal to an external server.

### INDUSTRIAL APPLICABILITY

The communication device of the present invention exhibits the effect that deterioration of a communication environment can be monitored in real time in the event that the communication environment deteriorates due to external factors, and therefore can be widely applied to various systems that include an communication device.

### REFERENCE SIGNS LIST

1 communication system
10 communication device
11 communication unit
11a wireless communication module
11b control unit (signal acquisition unit)
11c storage unit
11ca sensor log data
11cb communication environment log data
11d communication processing unit
11da communication control unit (radio field strength acquisition unit)
11db antenna
11e network device
20 sensor module
21a to 21d sensors (external devices)
30 communication network
31 cloud server (external server)
31a data input unit (data acquisition unit)
31b storage unit
31ba sensor log data
31bb communication environment log data
31bc determination threshold
31c display and notification control unit (notification unit)
31d data analysis unit (analysis unit)
32 user terminal device
101 communication system
110 communication device
111 communication unit
111cc determination threshold
111f data analysis unit
131 cloud server

1. A communication device that acquires an output signal from an external device and transmits it to an external server, the communication device comprising:
a signal acquisition unit configured to acquire an output signal from the external device;
a communication unit configured to transmit the output signal acquired by the signal acquisition unit to the external server; and
an analysis unit configured to acquire a radio field strength of the signal transmitted from the communication unit to the external server and analyzes a communication environment between the communication unit and the external server.

2. A communication system, comprising an external device, an external server, and a communication device that acquires an output signal from the external device and transmits it to the external server,
wherein the communication device has:
a signal acquisition unit configured to acquire an output signal from the external device;
a communication unit configured to transmit the output signal acquired by the signal acquisition unit to the external server; and
a radio field strength acquisition unit configured to acquire a radio field strength of the output signal transmitted from the communication unit, and
the external server has:
a data acquisition unit configured to acquire data about the output signal and the radio field strength from the communication unit of the communication device; and
an analysis unit configured to analyze a communication environment between the communication device and the external server on the basis of a magnitude of the radio field strength.

3. The communication system according to claim 2,
wherein the analysis unit determines that the communication environment has deteriorated if the radio field strength acquired by the data acquisition unit is lower than an average value of past radio field strengths by at least a specific threshold.

4. The communication system according to claim 3,
wherein the analysis unit updates the threshold by averaging the radio field strength acquired during a specific period in which the data acquisition unit was able to receive the output signal properly.

5. The communication system according to claim 2,
wherein the analysis unit determines that the communication environment has deteriorated if data loss has occurred at least a specific number of times when receiving the output signal acquired by the data acquisition unit.

6. The communication system according to claim 2,
wherein the external server further has a notification unit that notifies a user of an analysis result for the communication environment in the analysis unit.

7. The communication system according to claim 2,
wherein the analysis unit uses RSSI (received signal strength indicator) or RSRP (reference signal received power) data as the data for analysis using radio field strength.

8. The communication system according to claim 2,
wherein the external server further has a storage unit configured to store data about the output signal and the radio field strength acquired by the data acquisition unit.

9. The communication system according to claim 2,
wherein the external device includes either a weather sensor that acquires weather data, a power monitoring sensor that acquires power information, or an agricultural sensor that acquires information from equipment that grows crops.

10. A communication method that makes use of a communication system comprising an external device, an external server, and a communication device that acquires an output signal from the external device and transmits it to the external server, the method comprising:
a signal acquisition step in which a signal acquisition unit of the communication device acquires an output signal from the external device;
a communication step in which a communication unit of the communication device transmits the output signal acquired by the signal acquisition unit to the external server;
a radio field strength acquisition step in which a radio field strength acquisition unit of the communication device acquires the radio field strength of the output signal transmitted from the communication unit;
a data acquisition step in which a data acquisition unit of the external server acquires data about the output signal and the radio field strength from the communication unit of the communication device; and
an analysis step in which an analysis unit of the external server analyzes a communication environment between the communication device and the external server on the basis of a magnitude of the radio field strength.

11. A communication program executed by a communication system comprising an external device, an external server, and a communication device that acquires an output signal from the external device and transmits it to the external server, the program causing a computer to execute a method comprising:
a signal acquisition step in which a signal acquisition unit of the communication device acquires an output signal from the external device;
a communication step in which a communication unit of the communication device transmits the output signal acquired by the signal acquisition unit to the external server;
a radio field strength acquisition step in which a radio field strength acquisition unit of the communication device acquires the radio field strength of the output signal transmitted from the communication unit;
a data acquisition step in which a data acquisition unit of the external server acquires data about the output signal and the radio field strength from the communication unit of the communication device; and
an analysis step in which an analysis unit of the external server analyzes a communication environment between the communication device and the external server on the basis of a magnitude of the radio field strength.
